(19) United States
(12) Patent Application Publication
(10) Pub. No.: US 2013/0182323 A1
(43) Pub. Date: Jul. 18, 2013

(54) Stereoscopic Image Capture System Comprising Means for Calibration of the Image Capture Lenses

(71) Applicants: Patrick DEFAY, L'Etrat (FR); Elvir MUJIC, St Just St Rambert (FR)

(72) Inventors: Patrick DEFAY, L'Etrat (FR); Elvir MUJIC, St Just St Rambert (FR)

(73) Assignee: THALES, Neuilly-sur-Seine (FR)

(21) Appl. No.: 13/554,229

(22) Filed: Jul. 20, 2012

(30) Foreign Application Priority Data
Jul. 22, 2011 (FR) 11 02292

(51) Int. Cl. G02B 27/22

(52) U.S. Cl. CPC G02B 27/22
USPC 359/464

(57) ABSTRACT

In the field of stereoscopic image capture systems comprising two cameras, each camera comprising a lens and an electromechanical device allowing the adjustments of the lens to be controlled, a system is provided which comprises calibration means comprising means for storing adjustment setpoints fixed by an operator in operational use and control means allowing the adjustment setpoints of the first lens and those of the second lens to be closed-loop controlled in such a manner that the optical parameters of the first and of the second lens are identical.

### CROSS-REFERENCE TO RELATED APPLICATION

This application claims priority to foreign French patent application No. FR 1102292, filed on Jul. 22, 2011, the disclosure of which is incorporated by reference in its entirety.

### FIELD OF THE INVENTION

The field of the invention is that of image capture systems referred to as “3D” or stereoscopic image capture systems. Several cameras and lenses are needed for capturing images according to several different angles of view. Stereoscopic effects can rely on two images, one left and one right, or on a set of several images only one pair of which can be seen by the viewer depending on his position in front of the projection device. The latter system enables the broadcasting of 3D images known as “multi-view images”. If the viewer moves in front of the projected 3D image, he sees the objects displayed move as they would in reality.

### BACKGROUND

“3D” vision corresponds to an interpretation by the brain of images seen by both eyes in order to assign a position to the objects in space. The position assigned depends on the differences between the images seen by both eyes of the viewer. If the object is moving, the images must be synchronous, taken at the same moment in time, in order that the movement of the object between two left and right images taken successively is not interpreted as distance information.

FIGS. 1, 2 and 3 show 3D image capture systems 1. The systems shown comprise two cameras. The mechanical components which support the cameras and their adjustment turntables are not shown in these figures. Each camera 10 comprises three main sub-assemblies which are:
A sensor unit 11 comprising a photosensitive sensor and the associated electronic control means;
An optical lens 12 which is generally a zoom lens. At least three parameters are adjustable on this type of optics: the focal length, the focusing and the aperture;
An electromechanical device 13 allowing the adjustment means for the various parameters to be controlled.

FIG. 1 shows a first embodiment of the image capture system. In this first embodiment, the cameras 10 are simply placed side by side, the optical axes of the lenses 12 being in the same plane. The two optical axes are not necessarily parallel.

The drawback of the system in FIG. 1 is that the distance d separating the two optical axes of the lenses necessarily has a minimum value associated with the size of the optics and of their supports. The stereoscopic effect is thus limited in certain image capturing configurations.

The system shown in FIGS. 2 and 3 does not have this drawback. It comprises two cameras disposed perpendicularly with respect to one another and separated by a semi-reflecting plate 14 disposed at 45 degrees to the axes of the lenses 12. FIG. 3 shows a front view of this system and FIG. 3 a top view. In this configuration, the mechanical limitation disappears and it is possible, as can be seen in FIG. 3, to separate the optical axes by the desired distance d at the cost however of a photometric attenuation and of a slight difference in optical path on one of the channels due to the semi-reflecting plate.

If the camera/lens assemblies do not have the same characteristics such as the framed or covered field, the “magnification”, the alignment of the channels, the focusing, etc., the brain can no longer compare the two images which are too disparate.

When shooting a 3D film or taking a 3D photograph, the cameraman must choose a focus plane, and this plane can also move during image capture in order to follow the movements of the scene. The cameraman must therefore modify the focusing distance of all of the lenses used. In order to preserve a coherence between the images taken by the various cameras, this modification must be carried out at the same moment on all the lenses which must therefore be synchronized in time and functionally and be controlled by a single control command.

When the cameraman modifies the single control command for the focusing position of the system, all the lenses focus at the same focusing distance. When he stops on a focusing distance, all the lenses stop at the same focusing distance at the same time. This behaviour must be identical for the framed field, the focusing and the aperture of the diaphragm of the lenses which can depend on the differences in sensitivity of the cameras. However, the static and dynamic characteristics of the lenses and of the cameras are different from one camera to another or from one lens to another.

In order to solve this problem, in the known techniques of the prior art, lenses are fabricated with a precision such that these lenses are practically identical both in their optical combination and in their displacement mechanism needed for the focusing and for the zoom functions. This relies on the precision and the “repeatability” of manufacture of the mechanical and/or optical components making up the system. Sorting of the lenses is also used in such a manner as to identify and associate lenses having a similar behaviour, often coming from the same manufacturing lot.

The flaws in this solution are:
Difficulties in obtaining all the critical components coming from the same lot, particularly in an industrial environment;
Although coming from the same lot, the lenses integrated and adjusted by operators cannot have a perfectly identical behaviour;
The lenses are optimized at the start of the production line, but their behaviour drifts with the wear of the mechanical components. Their behaviours end up by diverging with no possibility for correction;
All the possible configurations cannot be covered by the manufacturer: all the focal lengths, all the focusing adjustments, all the cameras with their intrinsic defects, all the temperatures of operation, all the operating positions of the lenses, etc.

Another solution of the prior art consists in calibrating a slave lens on another lens considered as master. Since this procedure is complex, it is carried out at the factory by the manufacturer of lenses or of the image capture system. The main flaws in this solution are:
The lenses are matched at the factory, a fact which creates difficulties for the after-sale service. The lens-master and the lens-slave or the lenses-slaves must necessarily be perfectly identified;
All the possible configurations cannot be covered by the manufacturer:

all the focal lengths, all the focusing adjustments, all the cameras with their intrinsic defects, all the temperatures of operation, all the operating positions of the lenses, etc.;
As previously, the lenses are optimized at the start of the production line, but their behaviour drifts with the wear of the mechanical components. Their behaviours end up by diverging with no possibility for correction;
Depending on the type of use, for example, when the lenses are situated on either side of a semi-reflecting mirror, the lenses require a different synchronization.

### SUMMARY OF THE INVENTION

The system according to the invention does not have these drawbacks. It comprises calibration means allowing the system to be calibrated in a real situation, under the conditions of the image capture and in a time that can immediately precede the image capture, thus avoiding any later drift during the image capture.

More precisely, the subject of the invention is a stereoscopic image capture system comprising at least a first camera and a second camera,
the first camera comprising a first lens, said first lens comprising first means of adjustment of at least one optical parameter and a first electromechanical device allowing said first adjustment means to be controlled,
the second camera comprising a second lens, said second lens comprising second means of adjustment of the same optical parameter and a second electromechanical device allowing said second adjustment means to be controlled,
characterized in that each electromechanical device comprises two modes of operation:
a “storage” mode in which storage means record adjustment setpoints for the first adjustment means, each setpoint corresponding to a predetermined value of an optical parameter, said value being common to the two cameras;
an “image capture” mode in which, the value of an optical parameter being selected, each adjustment setpoint corresponding to the value of said optical parameter is applied to the corresponding adjustment means by the corresponding electromechanical device.

Advantageously, the optical parameter is the focusing and/or the focal length of the lens.

Advantageously, the storage means comprise several setpoint values for the same parameter. The storage means comprise means configured so as to calculate intermediate setpoint values from the stored setpoint values, thus allowing an optical parameter to be continuously closed-loop controlled over its whole range of variation.

Advantageously, the cameras are installed either side by side, the optical axes of the lenses being in the same plane, or are disposed on either side of a thin semi-reflecting plane plate.

### BRIEF DESCRIPTION OF THE DRAWINGS

The invention will be better understood and other advantages will become apparent upon reading the description that follows presented in a non-limiting manner and thanks to the appended figures amongst which:

FIG. 1, already discussed, shows a first embodiment of a stereoscopic system with two cameras;

FIGS. 2 and 3, already discussed, show a second embodiment of a stereoscopic system with two cameras;

FIG. 4 shows a stereoscopic image capture system according to the invention.

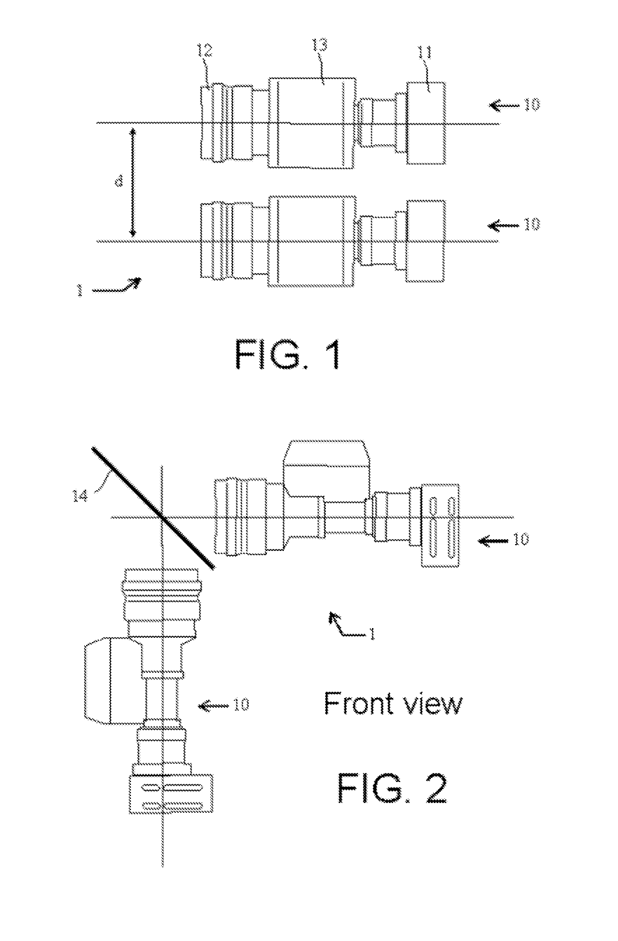

### DETAILED DESCRIPTION

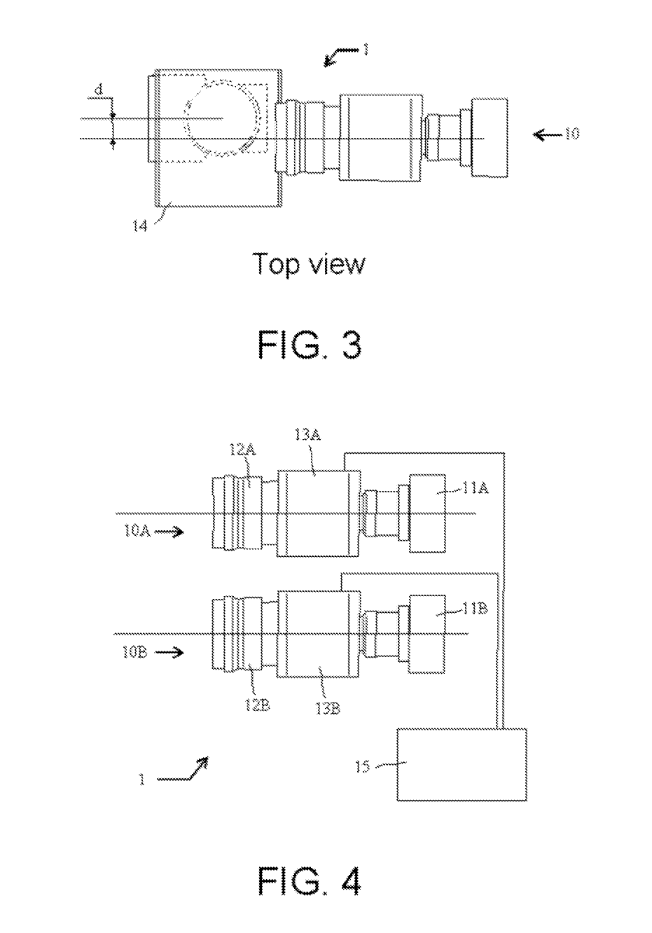

By way of non-limiting example, FIG. 4 shows a stereoscopic image capture system 1 comprising a first camera 10A and a second camera 10B disposed in a side-by-side configuration. Of course, the invention may be applied to other configurations of image capture systems such as, for example, a configuration with two cameras with a semi-reflecting mirror such as shown in FIGS. 2 and 3. It may also be extended to an assembly comprising more than two cameras.

Each camera 10A or 10B comprises a photodetection unit 11A or 11B, an optical lens 12A or 12B and an electromechanical device 13A or 13B for controlling the means for adjusting the lenses 12A and 12B. Generally speaking, the lenses 12A and 12B are optical zoom lenses the focusing, value of the focal length and aperture diaphragm of which can be adjusted. The focusing and the focal length are adjusted by internal displacements of lenses or of groups of lenses.

The two cameras 10A and 10B are substantially identical and the optical axes of the lenses 12A and 12B are in the same plane. The mechanical components that support the cameras 10A and 10B and their adjustment turntables are not shown in this FIG. 4.

The system 1 additionally comprises control means 15 which may take the form of a control handle.

The electromechanical devices 13A and 13B comprise means of storing setpoint values for the means of adjustment of the first lens 12A and of the second lens 12B. Each setpoint value CA for the first lens 12A is associated with a setpoint value CB for the second lens 12B in such a manner that, when the two adjustment setpoints CA and CB are applied to the lenses, a value of an optical parameter for the first lens 12A is identical to a value of the same optical parameter for the second lens 12B. As examples of optical parameter, the focusing or the value of the focal length may be mentioned.

Thus, when the control means 15 send the value of a parameter to be applied to the lenses 12A and 12B, the first electromechanical device 13A commands an adjustment setpoint CA on the first lens 12A, the second electromechanical device 13B commands the adjustment setpoint CB corresponding thereto in such a manner that the optical parameter for the two lenses 12A and 12B is identical. In other words, the two lenses 12A and 12B then have the same magnification, the same focusing and the same relative aperture.

The control means can be disposed in a control handle in order to facilitate the use of the image capture system by the operator which will comprise two modes of operation, a calibration or storage mode and a use or image capture mode.

The operational functioning of the device is very simple for the operator.

In a first step, the operator installs his lenses 12A and 12B on the cameras 10A and 10B.

In a second step, depending on the parameters of the image capture to be carried out, which are essentially the focusing distance, the desired depth of field, the width of the field, the operator adjusts for example the lens 12A in such a manner as to obtain the desired framing with a sharp focusing directly on the scene intended to be filmed. This operation is carried out by means of the control handle 15 which controls the electromechanical device 13A. Once the adjustments have been made, the setpoints corresponding to this configuration of the lens 12A, which may comprise one or more optical parameters, are stored. These parameters are for example the focusing and the value of the focal length of the lens 12A.

In a third step, the operator adjusts the lens 12B in the same way still by means of the control handle 15 and of the electromechanical device 13B in such a manner as to obtain optical parameters for the lens 12B identical to those of the lens 12A. The setpoints corresponding to this configuration are stored. These setpoint values can be different from those of the camera 10A.

It goes without saying that the operator may repeat the second and the third step several times in order to record several matching configurations for the lenses 12A and 12B corresponding, for example, to several different focal lengths.

At the time of the image capture, when the operator commands a configuration comprising one or more parameters, the correct setpoints are automatically generated so as to obtain identical parameters on the two cameras at the time of the recording. Thus, the two lenses always have, in a synchronous manner, the same focusing, the same aperture and the same focal length.

The advantages of this solution are manifold. The following will be mentioned:
The simplification of the lenses in production. The adjustment at the factory is limited to calibrating the lenses at a few points of the total range of use. The operator is still able to reposition two lenses even when they are not perfectly identical; it is no longer necessary to match them prior to installation;
The simplification of the after-sale service. In the case of a faulty lens, the new lens used just needs to be repositioned without taking any particular precautions on its characteristics;
The absence of degradations in the performance due to the wear of the lenses or to different thermal conditions. The periodic repositioning allows the defects introduced by the wear of the components of the lenses or the thermal variations to be corrected;
The lenses are readily adapted to various types of cameras having, for example, different positions of sensors or to various installation configurations that may comprise, for example, retro-reflecting mirrors of different thickness. Since the lenses are calibrated once the system has been installed, their behaviour both with regard to focusing, and to framed field, etc., is perfectly identical and compensates for all the defects introduced by the cameras, the mirrors, the optical filters, etc.
The simplification of the repositioning. The positions used in reality by the operator just need to be reset rather than the lens over all its range of use;
The facility of use. Since the lenses are able to be calibrated at several useful points for the image capture, the operations for zooming or for focusing, modified when the image capture occurs, are possible because, at any moment, the lenses are closed-loop controlled, synchronous and corrected for focal length or focusing control commands within the calibrated range. A single focal length handle and a single focusing handle control all of the lenses which therefore all receive the same commands at the same time.

1. A stereoscopic image capture system comprising at least a first camera and a second camera,
the first camera comprising a first lens, said first lens comprising first means of adjustment of at least one optical parameter and a first electromechanical device allowing said first adjustment means to be controlled, the second camera comprising a second lens, said second lens comprising second means of adjustment of the same optical parameter and a second electromechanical device allowing said second adjustment means to be controlled,
wherein each electromechanical device comprises two modes of operation:
a “storage” mode in which storage means record adjustment setpoints for the first adjustment means, each setpoint corresponding to a predetermined value of an optical parameter, said value being common to the two cameras;
and
an “image capture” mode in which, the value of an optical parameter being selected, each adjustment setpoint corresponding to the value of said optical parameter is applied to the corresponding adjustment means by the corresponding electromechanical device.

2. The stereoscopic image capture system according to claim 1, wherein the optical parameter is the focusing and/or the focal length of the lens.

3. The stereoscopic image capture system according to claim 1, wherein the storage means comprise several setpoint values for the same parameter.

4. The stereoscopic image capture system according to claim 3, wherein the storage means comprise means configured so as to calculate intermediate setpoint values from the stored setpoint values, thus allowing an optical parameter to be continuously closed-loop controlled over its whole range of variation.

5. The stereoscopic image capture system according to claim 1, wherein the cameras are installed side by side, the optical axes of the lenses being in the same plane.

6. The stereoscopic image capture system according to claim 1, wherein the cameras are disposed on either side of a thin semi-reflecting plane plate.
